(19) United States
(12) Patent Application Publication
(10) Pub. No.: US 2011/0133862 A1
(43) Pub. Date: Jun. 9, 2011

(54) TUNABLE FILTER CAPABLE OF CONTROLLING TUNING CHARACTERISTICS

(76) Inventors: Dong-Wan Chun, Incheon-si (KR); Kwang-Sun Park, Kyeonggi-do (KR)

(21) Appl. No.: 13/056,814

(22) PCT Filed: Aug. 7, 2009
(86) PCT No.: PCT/KR2009/004420

§ 371 Date: Jan. 31, 2011

(30) Foreign Application Priority Data
Aug. 7, 2008 (KR) 10-2008-0077660

(51) Int. Cl. H01P 1/208; H01P 5/04

(52) U.S. Cl. 333/209; 333/253

(57) ABSTRACT

A tunable filter for enabling the adjustment of tuning characteristics includes: a housing, in which multiple cavities are defined by partitions; a resonator contained in the cavity; at least one sliding member installed over the resonator; a main cover coupled to an upper portion of the housing; and at least one tuning element coupled to a lower portion of the sliding member and made of a metallic material. The tuning element is coupled to the sliding member by a rotatable bolt, and the bolt is coupled to the tuning element at a point that is a particular distance away from a center of the tuning element. The tunable filter using a sliding system according to certain embodiments of the present invention has the advantage of enabling adjustment of tuning characteristics by way of the rotation of the tuning element, and accordingly, can be used adaptively in various environments.

### TECHNICAL FIELD

The present invention relates to a filter, more particularly to a tunable filter which can vary its filter characteristics such as center frequency and band width.

### BACKGROUND ART

A filter is a device for passing signals of only a certain frequency band from the inputted frequency signals, and is implemented in various ways. The band-pass frequency of an RF filter may be determined by the inductance and capacitance components of the filter, and the operation of adjusting the band-pass frequency of a filter is referred to as tuning.

In a communication system, such as a mobile communication system, certain frequency bands may be allotted to certain businesses, which may divide the allotted frequency bands into several channels for use. In the related art, communication businesses generally manufactured and used a separate filter that is for suitable for each frequency band.

In recent times, however, rapid changes in the communication environment have created a need for a filter to have variable properties, such as for the center frequency and bandwidth, for example, unlike the earlier environment for mounting filters. For varying the properties in this manner, a tunable filter may be used.

FIG. 1 illustrates the structure of a tunable filter according to the related art.

Referring to FIG. 1, a filter according to the related art may include a housing 100, an input connector 102, an output connector 104, a cover 106, and multiple numbers of cavities 108 and resonators 110.

An RF filter is a device for passing signals of only a certain frequency band from among the inputted frequency signals, and is implemented in various ways.

A number of walls may be formed within the filter, with the walls defining cavities 108 in which to hold the resonators, respectively. The cover 106 may include tuning bolts 112, as well as coupling holes for coupling the housing 100 with the cover 106.

The tuning bolts 112 may be coupled to the cover 106 and may penetrate inside the housing. The tuning bolts 112 may be arranged on the cover 106 in corresponding positions in relation to the resonators or in relation to particular positions inside the cavities.

RF signals may be inputted by way of the input connector 102 and outputted by way of the output connector 104, where the RF signals may progress through the coupling windows formed in the cavities, respectively. Each of the cavities 108 and resonators 110 may generate a resonance effect of the RF signals, and this resonance effect may filter the RF signals.

In a filter according to the related art, such as that shown in FIG. 1, the tuning of frequency and bandwidth may be achieved using the tuning bolts.

FIG. 2 is a cross-sectional view of a cavity in a filter according to the related art.

Referring to FIG. 2, a tuning bolt 112 may penetrate through the cover 106 to be located above a resonator. The tuning bolt 112 may be made of a metallic material and may be secured to the cover by way of screw-coupling.

Hence, the tuning bolt 112 can be rotated to adjust its distance to the resonator, and by thus varying the distance between the resonator 110 and the tuning bolt 112, tuning may be achieved. The tuning bolt 112 can be rotated manually, or a separate machine for rotating the tuning bolt 112 can be employed. If the tuning achieved at an appropriate position, the tuning bolt may be secured using a nut.

In a filter according to the related art, as the distance between the tuning bolt and the resonator is changed due to the rotation of the tuning bolt, the capacitance can also be changed. Capacitance is one of the parameters that determine the frequency of a filter, and therefore the center frequency of a filter can be changed by altering the capacitance.

With such a filter according to the related art, tuning is only possible during the initial production, and its structure makes it difficult to accomplish tuning during use. In order to solve such difficulties, a tunable filter was proposed which employs a sliding system, with which tuning can be performed comparatively easily.

For a tunable filter using a sliding system, a sliding member is installed which can slide between resonators; tuning elements made of metallic or dielectric material are attached to a lower portion of the sliding member; and such characteristics of the filter as resonance frequency and bandwidth are tuned by the sliding motion of the sliding member.

Such a tunable filter using the sliding system has the advantage of making tuning possible just by moving the sliding member side to side, without having to turn the bolts.

However, with such a tunable filter using a sliding system, the tuning range and the degree tuning according to the sliding were fixed, thus having the problem that it could not be used adaptively in various environments.

### DISCLOSURE

### Technical Problem

In order to resolve the aforementioned problems of the related art, the present invention proposes a tunable filter using a sliding system that enables the adjustment of tuning characteristics.

Another purpose of the present invention is to propose a tunable filter using a sliding system that can be used adaptively in various environments.

Other purposes of the present invention may be derived by those skilled in the art from the embodiments described below.

### Technical Solution

In order to fulfill the aforementioned purposes, an aspect of the present invention provides a tunable filter for enabling an adjustment of tuning characteristics. The tunable filter includes: a housing, in which multiple cavities are defined by partitions; a resonator contained in the cavity; at least one sliding member installed over the resonator; a main cover coupled to an upper portion of the housing; and at least one tuning element coupled to a lower portion of the sliding member and made of a metallic material. The tuning element is coupled to the sliding member by a rotatable bolt, and the bolt is coupled to the tuning element at a point that is a particular distance away from a center of the tuning element.

The positional relationship between the resonator and the tuning element is changed by the rotation of the bolts, and the bolt is secured by a nut.

A sub-cover is included between the main cover and the resonator, and the sub-cover has a guide groove for installing the sliding member.

At least one first guide member may be coupled to at least one side surface of the sliding member, where the first guide member may guide a sliding movement by way of contact with a side surface of the guide groove.

At least one second guide member may be coupled to an upper portion of the sliding member, where the second guide member may guide a sliding movement by way of contact with a lower portion of the main cover.

An elongated hole may be formed in the guide groove of the sub-cover, so as to allow the tuning element to be inserted in the housing and enable the tuning element to freely undergo a sliding movement.

Another aspect of the present invention provides a slider to be equipped in a tunable filter. The slider includes: a main body made of a dielectric material and placed over a resonator of the tunable filter at a particular distance; and a tuning element coupled to an upper portion of the main body and made of a metallic material. The tuning element is coupled to the main body by a rotatably inserted bolt, and the bolt is coupled to the tuning element at a point that is a particular distance away from a center of the tuning element.

### Advantageous Effects

The tunable filter using a sliding system according to certain embodiments of the present invention has the advantage of enabling adjustment of tuning characteristics by way of the rotation of the tuning element, and accordingly, can be used adaptively in various environments.

### DESCRIPTION OF DRAWINGS

FIG. 1 is a drawing illustrating the structure of a filter according to the related art.

FIG. 2 is a cross-sectional view of a cavity in a filter according to the related art.

FIG. 3 is an exploded perspective view of a tunable filter using a sliding system to which an embodiment of the present invention is applied.

FIG. 4 is a perspective view of a sliding member according to an embodiment of the present invention.

FIG. 5 is a plan view of a sliding member according to an embodiment of the present invention.

FIG. 6 is a cross-sectional view of a sliding member according to an embodiment of the present invention.

FIG. 7 is a drawing illustrating the coupling structure between a tuning element and a bolt according to the related art.

FIG. 8 is a drawing illustrating the coupling structure between a tuning element and a bolt according to an embodiment of the present invention.

FIG. 9 is a plan view illustrating the positional relationship between a tuning element and a resonator in a general condition.

FIG. 10 is a plan view illustrating the positional relationship between a tuning element and a resonator after changing the position of the tuning element by rotating the bolt.

FIG. 11 is a drawing illustrating an example of a resonator applicable to an embodiment of the present invention.

FIG. 12 is a drawing illustrating another example of a resonator applicable to an embodiment of the present invention.

FIG. 13 is a drawing illustrating yet another example of a resonator applicable to an embodiment of the present invention.

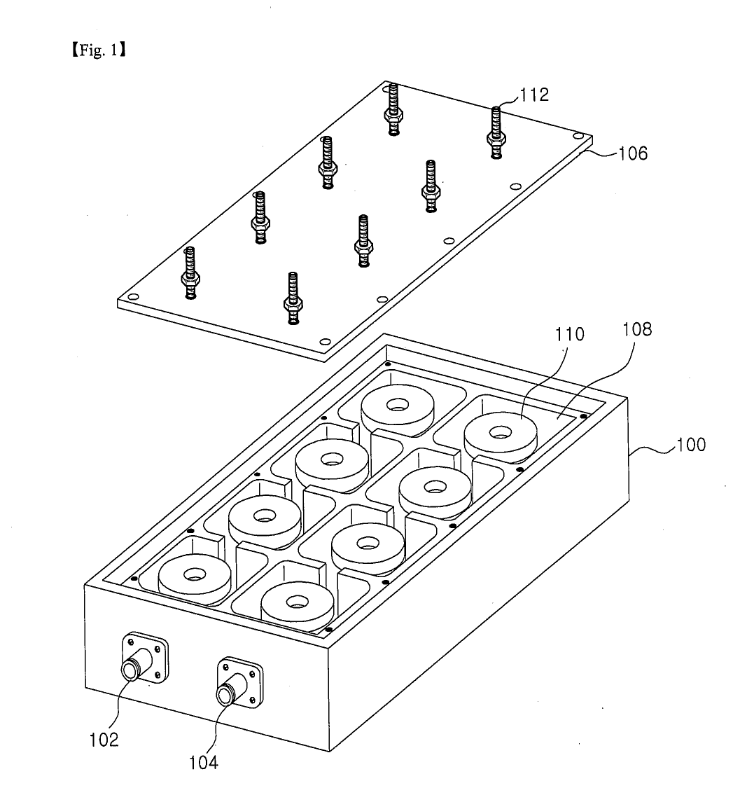

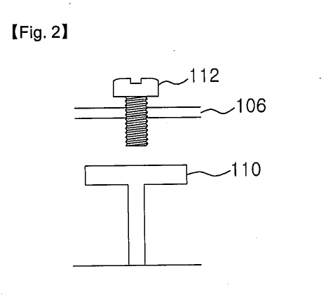

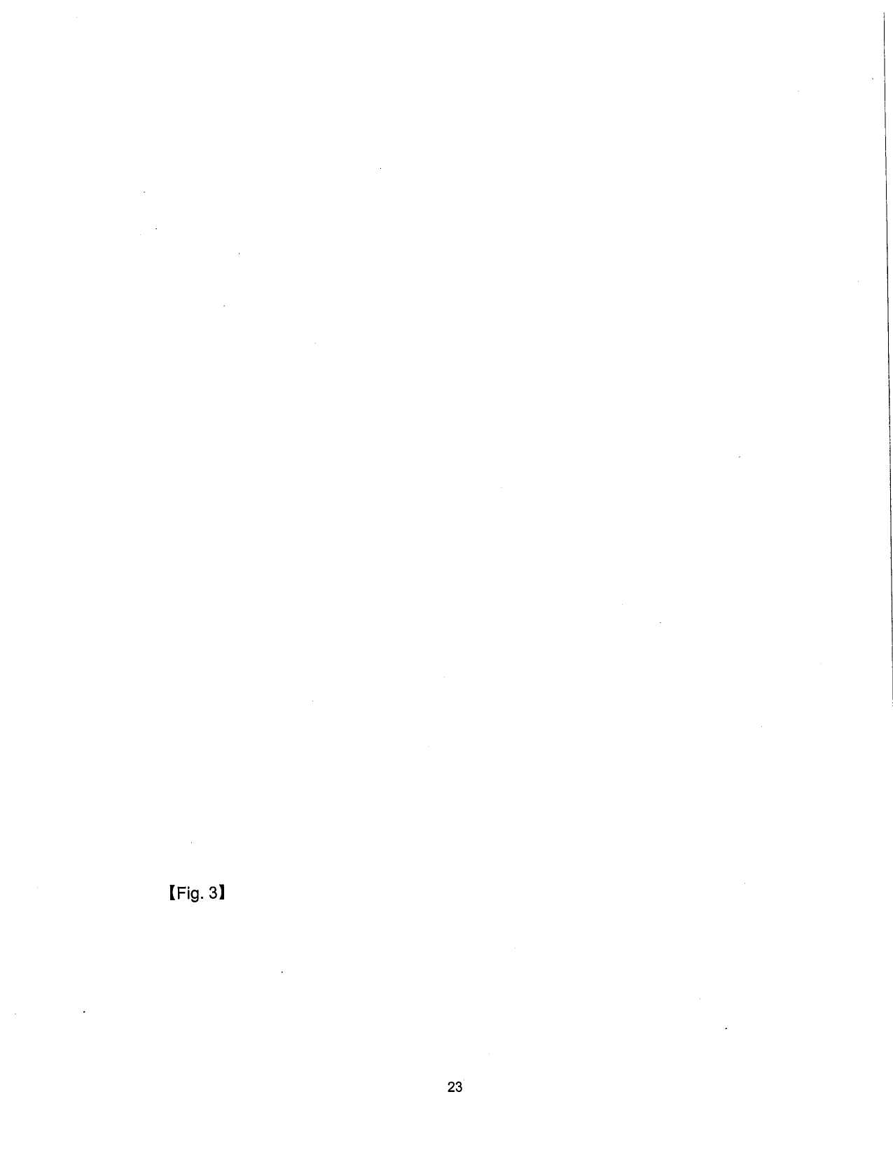

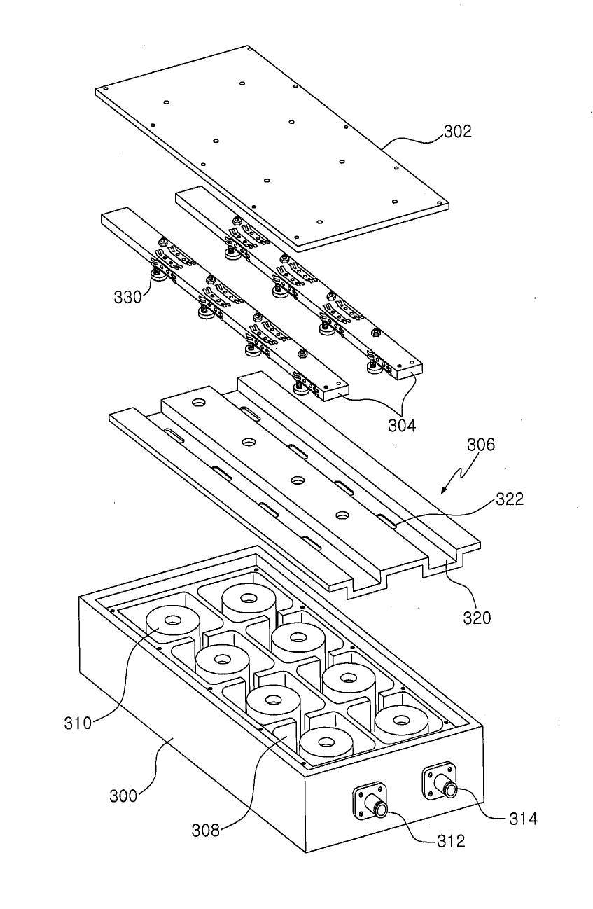

### MODE FOR INVENTION

Below, certain embodiments of a tunable filter for enabling the adjustment of tuning characteristics according to the present invention will be described in more detail with reference to the accompanying drawings.

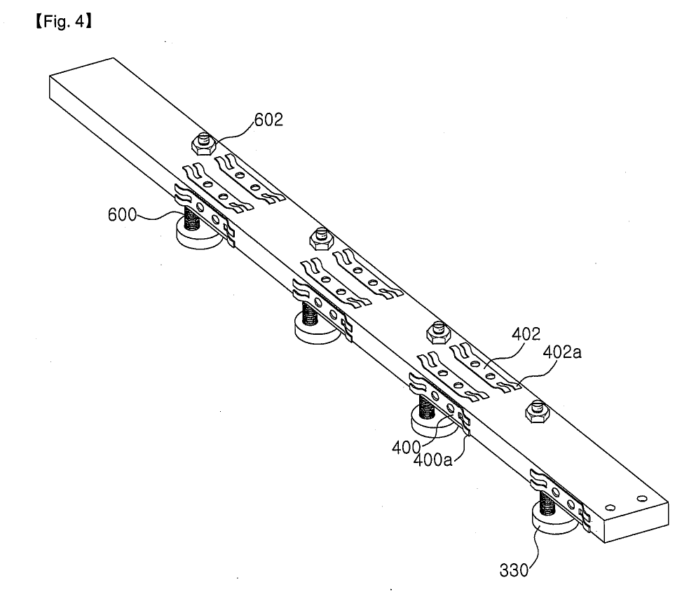

FIG. 3 is an exploded perspective view of a tunable filter using a sliding system to which an embodiment of the present invention is applied.

With reference to FIG. 3, a tunable filter using a sliding system, to which the present invention is applied, may comprise: a housing 300; a main cover 302; a sliding member 304; a sub-cover 306; multiple cavities 308; multiple resonators 310; an input connector 312; and an output connector 314.

The housing 300 performs the role of protecting the structural components such as resonators inside the filter and shielding electromagnetic waves. The housing 300 can be made by forming a base from an aluminum material and applying plating over the base. For RF equipment such as filters and waveguides, silver plating is generally used to minimize loss, due to its high electrical conductivity. In recent times, plating methods other than silver plating are also used, to improve properties such as corrosion resistance, for example, and a housing made using such plating methods can also be used.

The sub-cover 306 can be coupled to the housing at an upper portion of the housing, and can be coupled with the housing by bolts and fastening holes. Guide grooves 320 may be formed in the sub-cover 306, so that the sliding members 304 may undergo a sliding movement in a stable manner.

Inside the filter there are multiple partitions, and these partitions together with the filter's housing define the cavities 308, within which the resonators 310 are contained. The number of cavities and resonators is related to the order of the filter, with FIG. 3 illustrating an example having an order of eight, in other words, having eight resonators. The order of a filter is related to insertion loss and skirt characteristics. One faces a tradeoff, as a higher order of a filter results in improved skirt characteristics but poorer insertion loss, and the order of a filter may thus be set according to the insertion loss and skirt characteristics required.

In portions of the partitions, coupling windows may be formed in correspondence with the direction of progression of the RF signals. An RF signal that is resonated by a cavity and a resonator may progress through the coupling window into the next cavity.

The main cover 302 is coupled to an upper portion of the sub-cover 306, and may be fastened by bolts.

The sliding member 304 is installed so as to be able to slide in the directions orthogonal to the standing direction of the resonators; that is to say, in the horizontal directions. The sliding member 304 is installed in the guide groove formed into the top of the sub-cover, and may be made to slide automatically using a motor or manually by the user.

Although not shown in FIG. 3, the sliding member may be made to slide by a motor included inside the filter; a portion of the sliding member may protrude outside, being coupled with a motor that provides driving force. As driving mechanisms for the sliding member are widely known, a detailed explanation regarding it is omitted.

The number of sliding members 304 may correspond to the number of lines of resonators in the filter. FIG. 3 illustrates a filter having two lines of resonators, each line with four resonators, and corresponding to this, the number of sliding members 304 is shown to be two.

Coupled to a lower portion of each sliding member are tuning elements 330. The tuning elements 330 are put through the elongated holes 322 in the sub-cover 306 into the filter's interior, and these tuning elements 330 are made of a metallic material. On the other hand, the sliding member 304 should ideally be made of a dielectric material.

The tuning elements 330 are coupled to the underside of the sliding member 304, corresponding with the resonators 310 included in the filter. As there are four resonators under each of the sliding member 304, four tuning elements are coupled to the sliding member 304. Also, the interval between the tuning elements coupled corresponds to the interval between the resonators installed.

Corresponding with the sliding of the sliding member 304, the position of the coupled tuning elements 330 may also be varied. The tuning elements 330 form capacitance by their interaction with the resonators 310, and capacitance changes with the change in the position of the tuning elements 330.

Since capacitance is determined by the distance and the sectional area between two metals, the sectional area between the resonators and the tuning elements changes with the change in position of the metallic tuning elements, and accordingly, variance in capacitance occurs, making tuning possible as regards the characteristics of the filter.

If there are a multiple number of sliding members, the sliding members can be made to slide independently or can be made to slide collectively by means of a single motor. In cases where the sliding is performed collectively, it is possible to collectively apply tuning for all resonators of the filter.

Although it is not shown in FIG. 3, the tuning bolts for tuning may be inserted from the sub-cover 306 into the filter at the time of manufacture. The role of the inserted tuning bolts is the same as with the filter according to the related art.

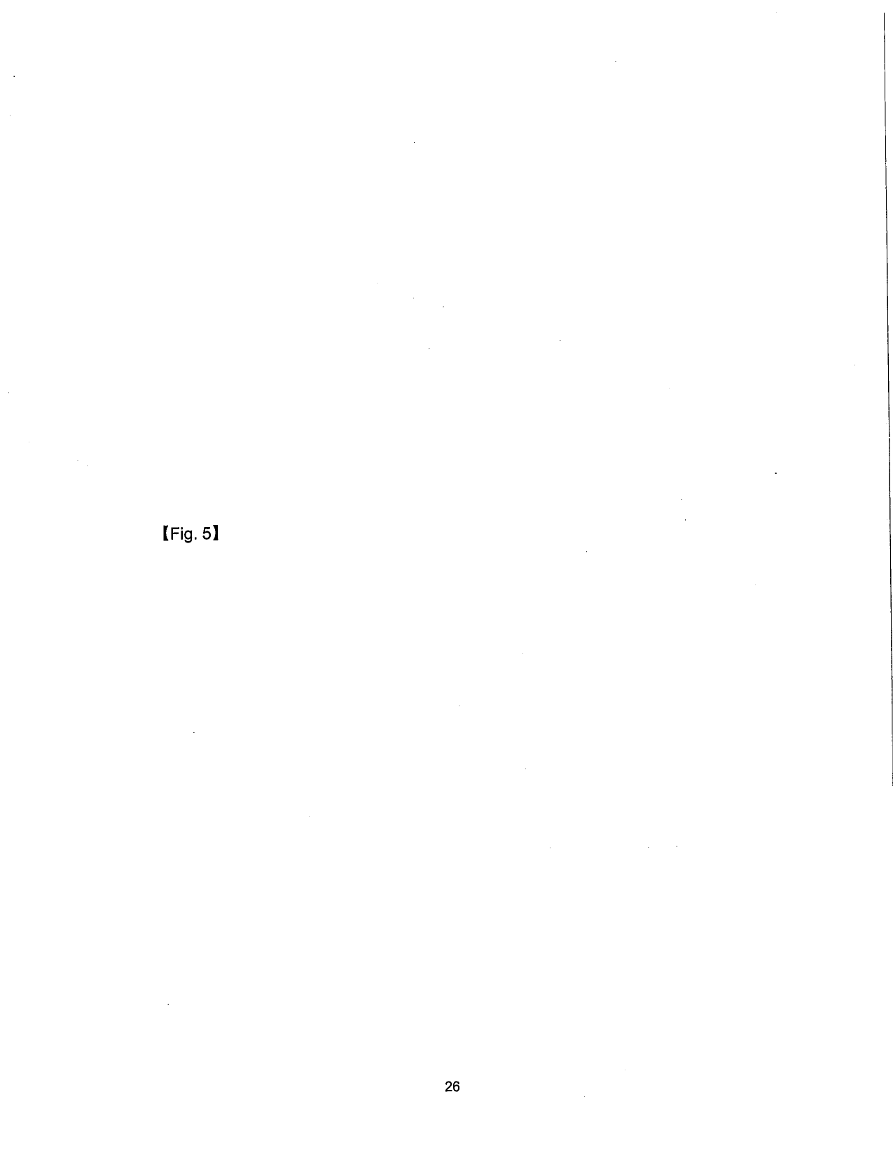

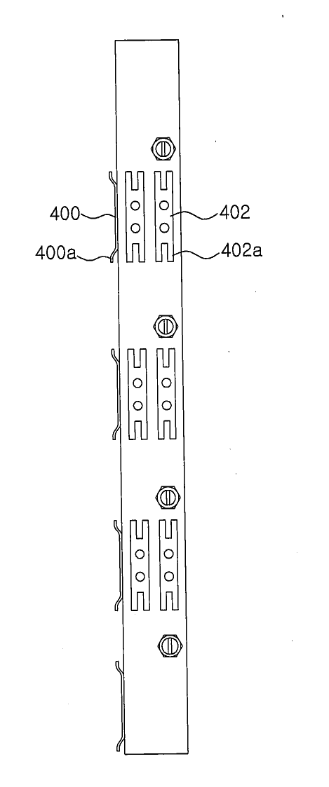

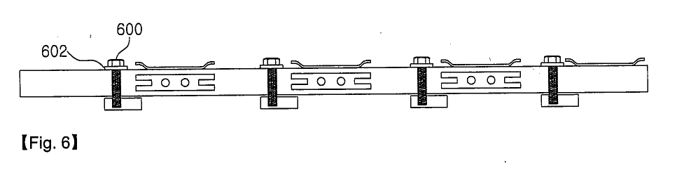

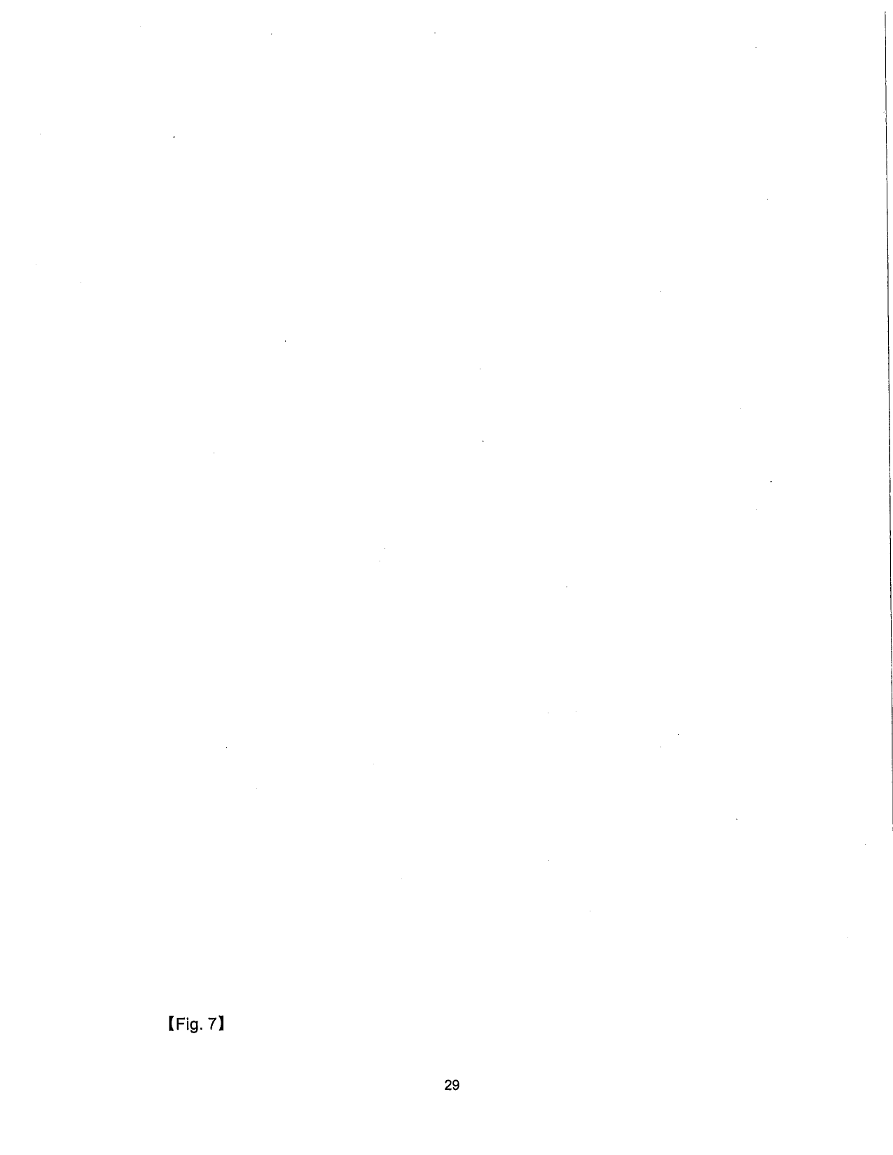

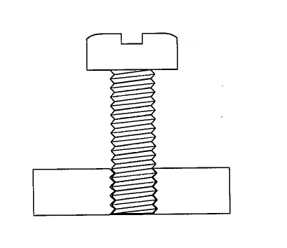

FIG. 4 is a perspective view of a sliding member according to an embodiment of the present invention, FIG. 5 is a plan view of a sliding member according to an embodiment of the present invention, and FIG. 6 is a cross-sectional view of a sliding member according to an embodiment of the present invention.

With reference to FIGS. 4 to 6, the tuning elements 330 are coupled to the sliding member in a particular interval, and as described above, the interval between the tuning elements 330 corresponds to the interval between the resonators.

With reference to FIG. 6, the metallic tuning elements 330 are coupled to the sliding member by bolts 600. FIG. 6 shows disc-shaped metallic tuning elements 330, but the shape of the tuning elements is not thus limited, and it would be apparent to those skilled in the art that it may be implemented in a variety of shapes.

The sliding member has screw threads formed so as to have the bolts 600 screwed through, and the bolts 600 are secured by nuts. The bolts 600 are coupled to the sliding member such that they can be rotated by a tool such as a screw driver.

With reference to FIGS. 4 to 6, several first guide members 400 may be coupled to one side of the sliding member 304, while several second guide members 402 may be coupled to an upper portion of the sliding member. While FIGS. 4 to 6 illustrate an example in which there are first guide members 400 coupled to one side only, the first guide members 400 can just as well be coupled to both sides of the sliding members 404.

The first guide members 400 and the second guide members 402 serve to guide the sliding member 304 to slide in a stable manner. The sliding member 304 should only slide along the length, and when sliding, any movement up-and-down or side-to-side should be eliminated.

The first guide member 400 and the second guide member 402 eliminate any unnecessary movement up-and-down or side-to-side and make the sliding member slide only in the predetermined directions.

According to a preferred embodiment of the invention, the first guide members 400 and second guide members 402 can be made from an elastic material, and can be implemented in the form of flat springs, for example.

With reference to FIGS. 4 to 6, the first guide member 400 and the second guide member 402 have the structure of flat springs having plural elastic wings 400a, 402a. The elasticity of the elastic bodies have the advantage of preventing the sliding member from moving in directions other than the sliding directions, and of minimizing friction when sliding.

The wings 400a, 402a are in contact with a side surface of the guide groove formed in the sub-cover and with the main cover, and allow stable guide motion due to their elasticity.

Besides this, the elastic bodies may be utilized as guide members in a variety of forms, and it would be apparent to those skilled in the art that such modifications are included within the scope of the present invention.

According to the related art, when the tuning elements are coupled by bolts, the bolts are coupled along the center line of the sliding member. FIG. 7 is a drawing illustrating the coupling structure between a tuning element and a bolt according to the related art.

As illustrated in FIG. 7, the bolt is coupled to the center of the tuning element, and in such an arrangement, the position of the tuning element is fixed. In a structure having tuning elements that are fixed, the tuning characteristics according to the sliding remain the same, thus the tuning characteristics cannot help but be fixed also, and the rate of change and tuning range for resonance frequency and bandwidth may not be changed.

In order to resolve such problems of the related art, an embodiment of the present invention proposes a structure that enables the adjustment of tuning characteristics by varying the positions of tuning elements.

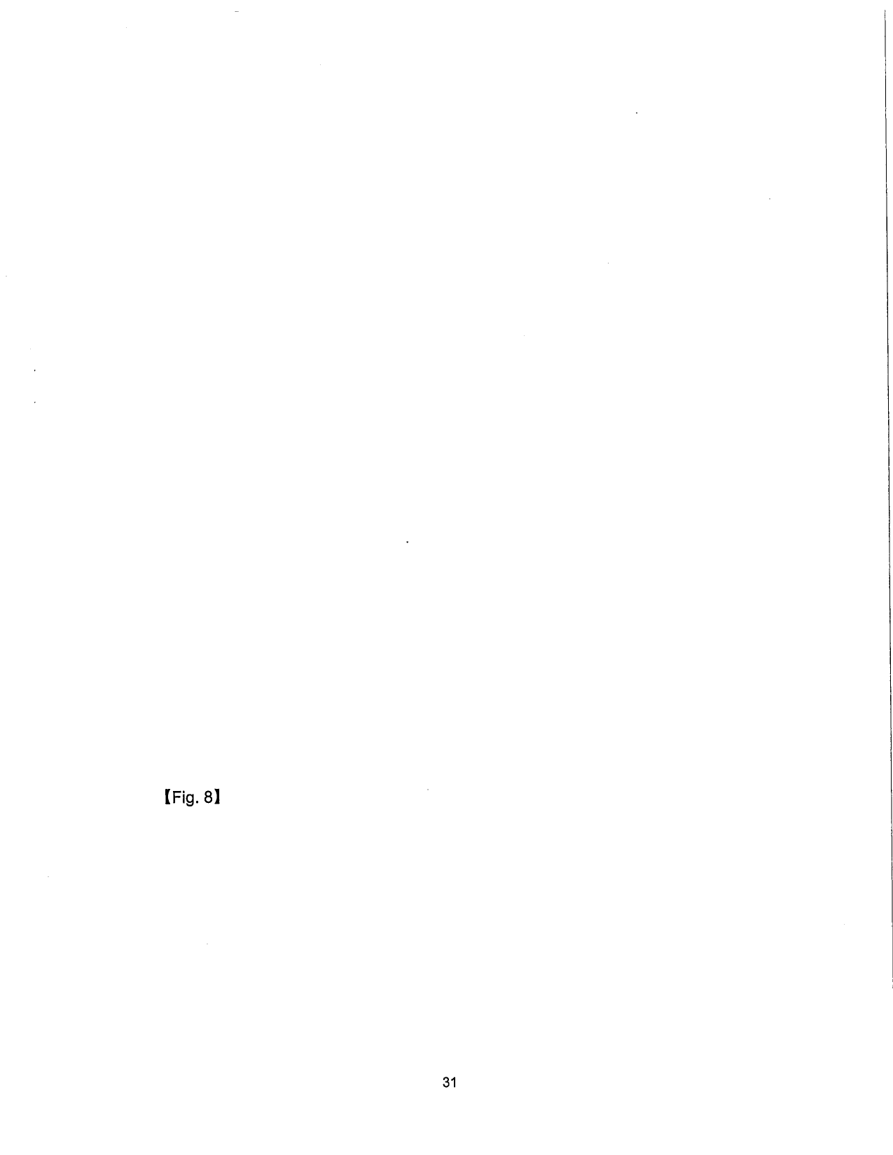

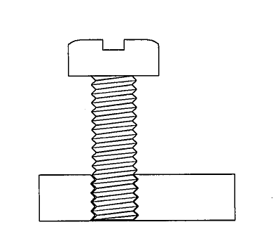

FIG. 8 is a drawing illustrating the coupling structure between a tuning element and a bolt according to an embodiment of the present invention.

With reference to FIG. 8, the bolt 800 is not coupled to the center of the tuning element 802, but rather, is coupled at a point that is a particular distance away from the center. As described above, the bolt 800 is installed so as to be rotatable, and when the bolt 800 is rotated, the position of the tuning element is changed.

In a tunable filter using a sliding system that uses metallic tuning elements, tuning is accomplished by the change in the area of overlap between the tuning elements and the resonators, one over the other, and as capacitance is changed accordingly, tuning of the filter is accomplished.

As in FIG. 8, if the bolt 800 is coupled at a particular distance away from the center of the tuning element, the positional relationship between the resonator and the tuning element is changed as the bolt is rotated, and accordingly, the tuning characteristics according to the sliding are also changed.

The user may obtain the desired tuning characteristics by rotating the bolt with the use of a tool such as a screw driver, thereby changing the position of the tuning element.

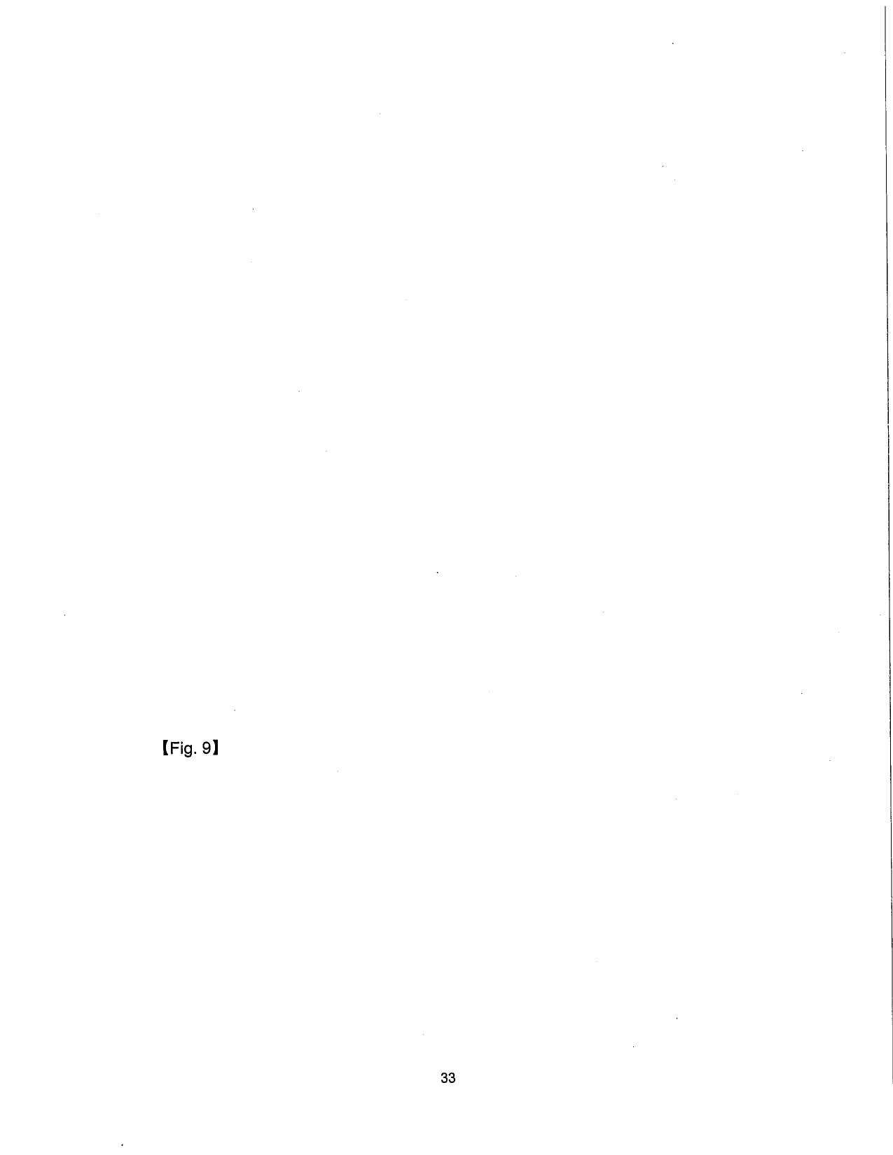

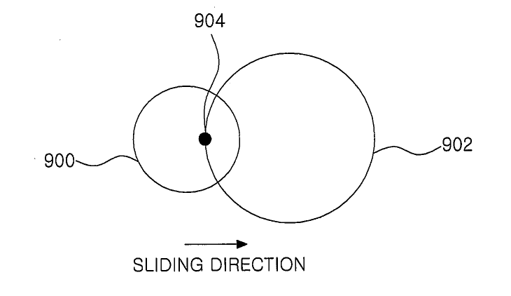

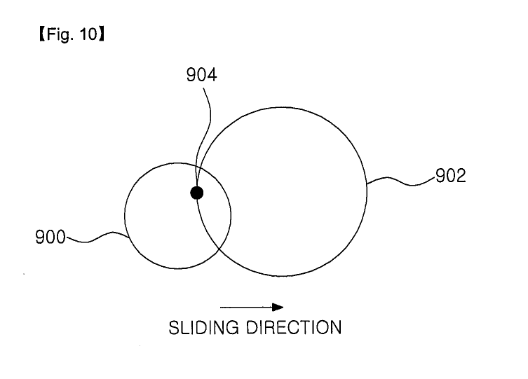

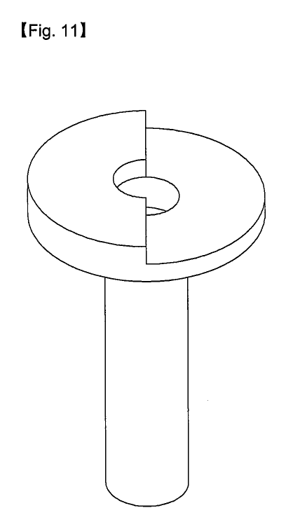

FIG. 9 is a plan view illustrating the positional relationship between a tuning element and a resonator in a general condition, and FIG. 10 is a plan view illustrating the positional relationship between a tuning element and a resonator after changing the position of the tuning element by rotating the bolt.

With reference to FIG. 9, the tuning element 900 slides in the direction of the arrow, and the area of overlap with the resonator 902, one over the other, changes in correspondence with the sliding.

Moreover, with reference to FIG. 10, the positional relationship between the tuning element and the resonator can be changed by the rotation of the bolt. If there is a change in the positional relationship in such a manner, the area of overlap with the resonator, one over the other, is also changed when the tuning element slides.

Consequently, the tuning characteristics are changed more, in comparison with the situation as in FIG. 9, and the user may use the tunable filter more adaptively in various environments.

FIG. 11 is a drawing illustrating an example of a resonator applicable to an embodiment of the present invention.

With reference to FIG. 11, the top of the resonator according to an embodiment of the present invention has a step. If the top of the resonator has a step as in FIG. 11, not only does the area of overlap between the tuning element and the resonator change, but also the distance between them changes when the bolt is rotated.

Consequently, if a resonator having the structure as in FIG. 11 is used, the tuning characteristics that are changed by the rotation of the bolt may be changed within a wider range.

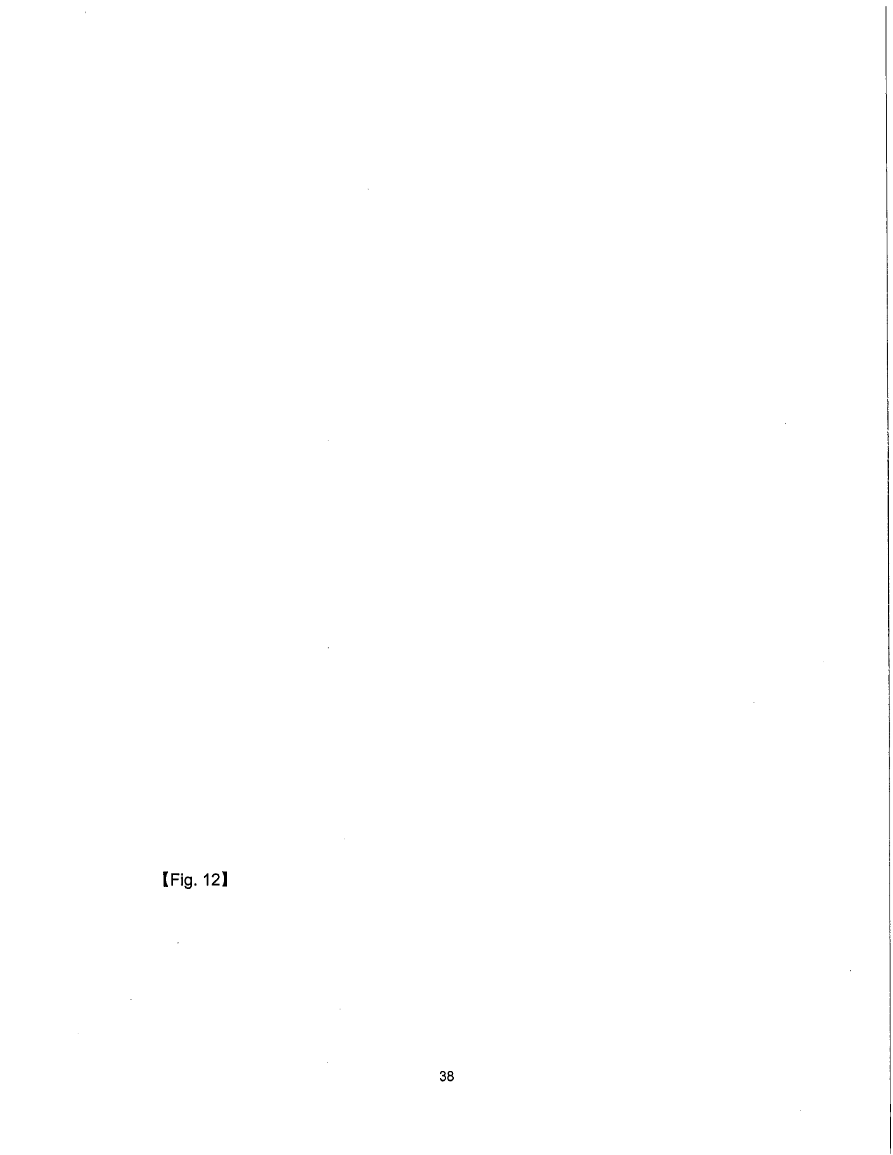

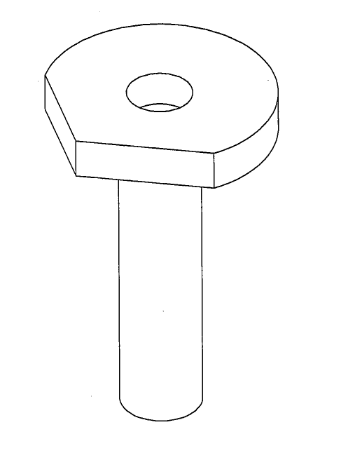

FIG. 12 is a drawing illustrating another example of a resonator applicable to an embodiment of the present invention.

With reference to FIG. 12, the disc-shaped conductor at the top of the resonator has portions of it cut off, so that the cross section is fan-shaped. If the disc-shaped conductor at the top of the resonator is cut away as in FIG. 12, in this case also, the changing of the tuning characteristics that are changed by the rotation of the bolt may be accomplished within a wider range.

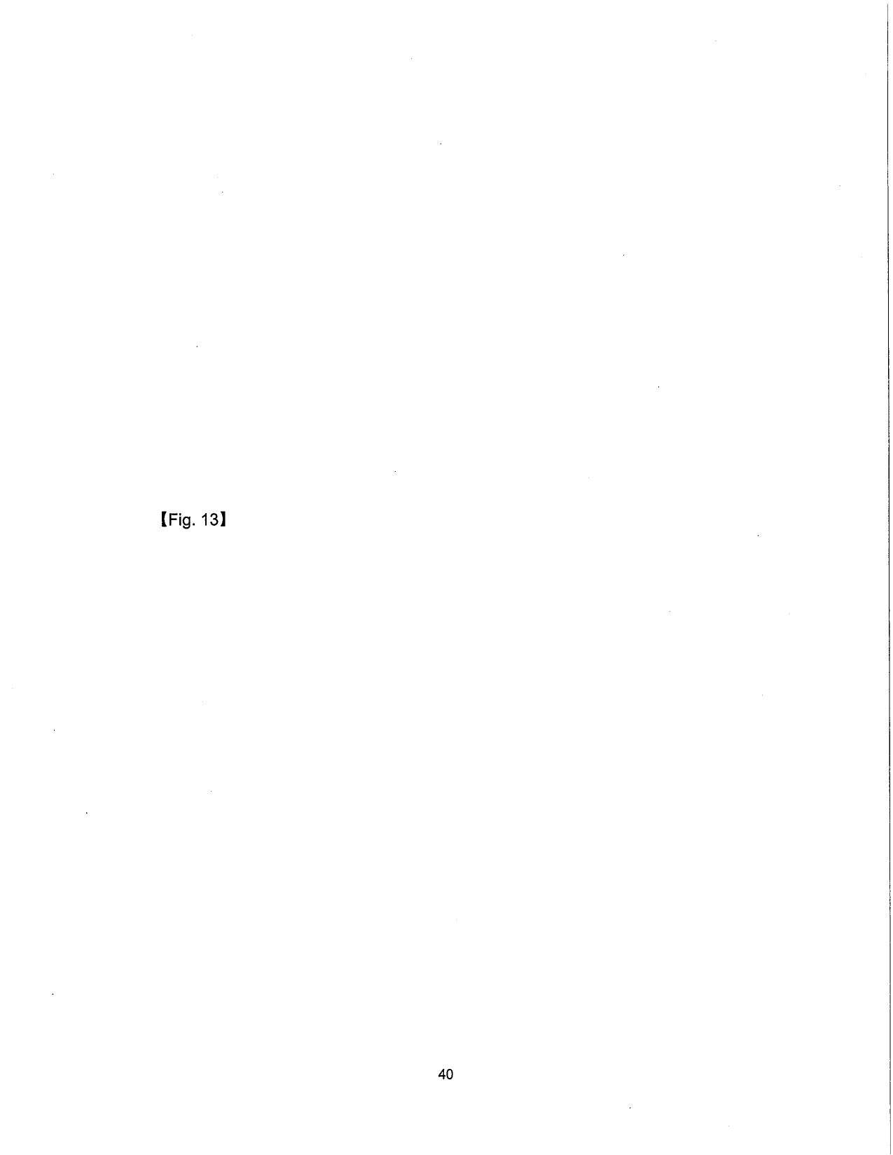

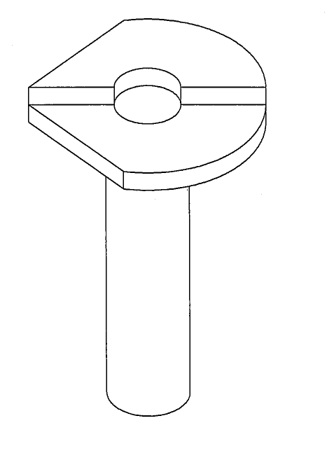

FIG. 13 is a drawing illustrating yet another example of a resonator applicable to an embodiment of the present invention.

The resonator in FIG. 13 has the structure combining the stepped structure of FIG. 11 and the structure of the disc-shaped conductor with portions cut off of FIG. 12. The resonator applied in FIG. 13 also enables the changing of the tuning characteristics by rotation to be accomplished within a wider range.

While the present invention has been described with reference to certain particular embodiments, it is to be appreciated that various changes and modifications may be made by those skilled in the art without departing from the spirit and scope of the present invention, as defined by the appended claims and their equivalents.

1. A tunable filter enabling an adjustment of tuning characteristics, the tunable filter comprising:
a housing having a plurality of cavities defined by partitions;
a resonator contained in the cavity;
at least one sliding member installed over the resonator;
a main cover coupled to an upper portion of the housing; and
at least one tuning element coupled to a lower portion of the sliding member and made of a metallic material,
wherein the tuning element is coupled to the sliding member by a rotatable bolt, and the bolt is coupled to the tuning element at a point that is a particular distance away from a center of the tuning element.

2. The tunable filter according to claim 1, wherein a positional relationship between the resonator and the tuning element is changed by a rotation of the bolt, and the bolt is secured by a nut.

3. The turnable filter according to claim 2, further comprising:
a sub-cover positioned between the main cover and the resonator, the sub-cover having a guide groove formed therein for installing the sliding member.

4. The turnable filter according to claim 3, wherein at least one first guide member is coupled to at least one side surface of the sliding member, the first guide member configured to guide a sliding movement by way of contact with a side surface of the guide groove.

5. The turnable filter according to claim 4, wherein at least one second guide member is coupled to an upper portion of the sliding member, the second guide member configured to guide a sliding movement by way of contact with a lower portion of the main cover.

6. The turnable filter according to claim 3, wherein an elongated hole is formed in the guide groove of the sub-cover, so as to allow the tuning element to be inserted in the housing and enable the tuning element to freely undergo a sliding movement.

7. The turnable filter according to claim 1, wherein the resonator is structured to have a step in an upper portion thereof.

8. The tunable filter according to claim 1, wherein the resonator is structured to have a portion removed from an upper portion thereof such that the resonator has a fan-shaped cross section.

9. A slider to be equipped in a tunable filter, the slider comprising:
a main body made of a dielectric material and placed over a resonator of the tunable filter at a particular distance; and
a tuning element coupled to an lower portion of the main body and made of a metallic material,
wherein the tuning element is coupled to the main body by a rotatably inserted bolt, and the bolt is coupled to the tuning element at a point that is a particular distance away from a center of the tuning element.

10. The slider according to claim 9, wherein a positional relationship between the resonator and the tuning element is changed by a rotation of the bolt, and the bolt is secured by a nut.
